(19) United States
(12) Patent Application Publication
(10) Pub. No.: US 2026/0121027 A1
(43) Pub. Date: Apr. 30, 2026

(54) POSITIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventor: Sungjin SEO, Yongin-si (KR)

(73) Assignee: SAMSUNG SDI CO., LTD., Yongin-si (KR)

(21) Appl. No.: 19/369,771

(22) Filed: Oct. 27, 2025

(30) Foreign Application Priority Data
Oct. 30, 2024 (KR) 10-2024-0150996

(51) Int. Cl. H01M 4/36; H01M 4/02; H01M 4/04; H01M 4/505; H01M 4/525; H01M 10/0525; H01M 10/0567

(52) U.S. Cl. CPC H01M 4/366; H01M 4/0404; H01M 4/0416; H01M 4/505; H01M 4/525; H01M 10/0525; H01M 10/0567; H01M 2004/021; H01M 2004/028

(57) ABSTRACT

Disclosed are positive electrodes and rechargeable lithium batteries. The rechargeable lithium battery includes a positive electrode that includes a current collector, an electrolyte, and a negative electrode. The positive electrode includes a first positive electrode active material layer on the current collector, and a second positive electrode active material layer on the first positive electrode active material layer. The second positive electrode active material layer includes a positive electrode active material that includes a lithium composite transition metal oxide, a plurality of pores, and a residual layer between the positive electrode active material and the pores. The residual layer includes sulfur (S).

### CROSS-REFERENCE TO RELATED APPLICATION

This application claims priority under 35 U.S.C § 119 to Korean Patent Application No. 10-2024-0150996 filed on Oct. 30, 2024 in the Korean Intellectual Property Office, the disclosure of which being hereby incorporated by reference in its entirety.

### BACKGROUND

Examples of the present disclosure relate to a positive electrode for a rechargeable lithium battery, and a rechargeable lithium battery including the positive electrode.

With increasing presence of battery-using electronic devices, such as, e.g., mobile phones, laptop computers, electric vehicles, and the like, there is increasing demand for rechargeable batteries with high energy density and high capacity. Therefore, improving performance of rechargeable lithium batteries may be advantageous.

A rechargeable lithium battery includes a positive electrode, a negative electrode, and an electrolyte, and the positive and negative electrodes include an active material in which intercalation and deintercalation are possible, and generates electrical energy caused by oxidation and reduction reactions when lithium ions are intercalated and deintercalated.

### SUMMARY

An example embodiment of the present disclosure includes a rechargeable lithium battery in which impregnation properties of an electrolyte is improved to enhance battery capacity, lifetime characteristics, and rapid charging characteristics.

According to an example embodiment of the present disclosure, a rechargeable lithium battery may include a positive electrode that includes a current collector; an electrolyte; and a negative electrode. The positive electrode may include a first positive electrode active material layer on the current collector; and a second positive electrode active material layer on the first positive electrode active material layer. The second positive electrode active material layer may include a positive electrode active material that includes lithium composite transition metal oxide; a plurality of pores; and a residual layer between the positive electrode active material and the pores. The residual layer may include sulfur (S).

According to an example embodiment of the present disclosure, a method of fabricating a rechargeable lithium battery may include coating on a current collector a first positive electrode slurry to form a first positive electrode active material layer; coating on the first positive electrode active material layer a second positive electrode slurry to form a second positive electrode active material layer; and providing an electrolyte on the first and second positive electrode active material layers. The second positive electrode slurry may include an additive. Providing the electrolyte may include releasing the additive from the second positive electrode active material layer; and allowing the released additive to form a plurality of pores in the second positive electrode active material layer.

According to an example embodiment of the present disclosure, a positive electrode for a rechargeable lithium battery may include a current collector; a first positive electrode active material layer on the current collector; and a second positive electrode active material layer on the first positive electrode active material layer. The second positive electrode active material layer may include a positive electrode active material that includes lithium composite transition metal oxide; a plurality of pores; and a residual layer between the positive electrode active material and the pores. The residual layer may include sulfur (S).

### BRIEF DESCRIPTION OF DRAWINGS

FIG. 1 illustrates a simplified conceptual diagram showing a rechargeable lithium battery according to an example embodiment of the present disclosure.

FIG. 2 to FIG. 5 illustrate simplified diagrams showing a rechargeable lithium battery according to an example embodiment of the present disclosure.

FIG. 6 illustrates a cross-sectional view showing a rechargeable lithium battery according to an example embodiment of the present disclosure.

FIG. 7 illustrates a cross-sectional view showing a positive electrode of a rechargeable lithium battery according to an example embodiment of the present disclosure.

FIG. 8 illustrates an enlarged view showing section “M” example according to an embodiment of the present disclosure.

FIG. 9 illustrates an enlarged view showing section “M” according to a comparative example of the present disclosure.

FIG. 10 illustrates a graph showing porosity as a function of X direction depicted in FIG. 7.

FIG. 11 illustrates a graph showing temperature and voltage in accordance with charging in each of some examples and comparative examples.

FIG. 12 is a flow chart illustrating a method of fabricating a rechargeable lithium battery, according to an example embodiment.

### DETAILED DESCRIPTION OF EMBODIMENTS

In order to sufficiently understand the configuration and effect of the present disclosure, some example embodiments of the present disclosure are described with reference to the accompanying drawings. It should be noted, however, that the present disclosure is not limited to the following example embodiments, and may be implemented in various forms. Rather, the example embodiments are provided to disclose examples of the present disclosure and let those skilled in the art fully know the scope of the present disclosure.

In this description, it is understood that, when an element is referred to as being “on” another element, the element can be directly on the other element, or intervening elements may be present therebetween. In the drawings, thicknesses of some components may be exaggerated for effectively explaining the technical contents. Like reference numerals refer to like elements throughout the specification.

Unless otherwise noted in this description, the expression of singular form may include the expression of plural form. In addition, unless otherwise noted, the phrase “A or B” may indicate “A but not B,” “B but not A,” and “A and B.” The terms “comprises/includes” and/or “comprising/including” used in this description do not exclude the presence or addition of one or more other components.

In this description, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) of particles having a cumulative volume of about 50 vol % in particle size distribution. The average particle diameter (D₅₀) may be measured by a method known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. A laser scattering method may be utilized to measure the average particle diameter (D₅₀). In the laser scattering method, a target particle is dispersed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

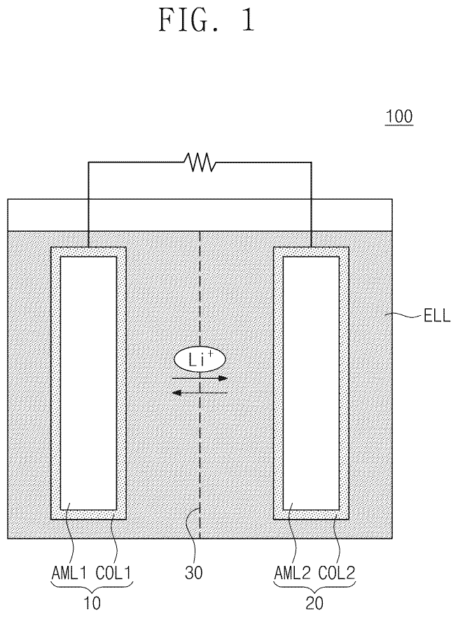

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

In a rechargeable battery including a gel polymer electrolyte (or semi-solid electrolyte) and a solid electrolyte, the rechargeable battery may include a solid electrolyte layer. In this case, the electrolyte layer may replace the separator 30 and the electrolyte ELL.

### Positive Electrode

The positive electrode 10 for the rechargeable lithium battery may include a current collector COL1 and a positive electrode active material layer AML1 formed on the current collector COL1. The positive electrode active material layer AML1 may include a positive electrode active material, and may further include a binder and/or a conductive material. An amount of the positive electrode active material in the positive electrode active material layer AML1 may range from about 90 wt % to about 99.5 wt % relative to 100 wt % of the positive electrode active material layer AML1. Amounts of the binder and the conductive material may each be in a range of about 0.5 wt % to about 5 wt % relative to 100 wt % of the positive electrode active material layer AML1. The positive electrode active material layer AML1 may further include a sacrificial positive electrode material and a functional additive. The following description focuses on the positive electrode according to an example embodiment of the present disclosure. Aluminum (Al) may be included as the current collector COL1, but the present disclosure is not limited thereto.

### Positive Electrode Active Material:

As discussed below with respect to FIG. 7, the positive electrode active material layer AML1 may include a first positive electrode active material layer LL, and a second positive electrode active material layer HL on the first positive electrode active material layer LL. The first positive electrode active material layer LL may be interposed between the positive electrode current collector COL1 and the second positive electrode active material layer HL. The first positive electrode active material layer LL may be adjacent to the positive electrode current collector COL1, and the second positive electrode active material layer HL may be adjacent to the separator 30.

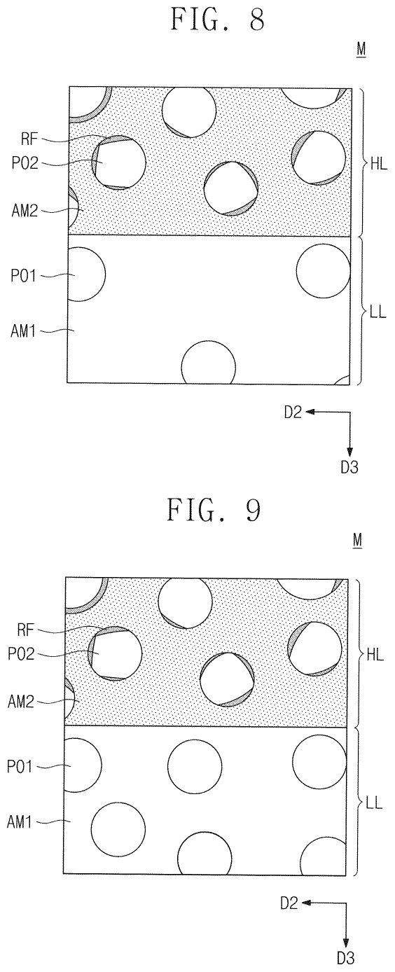

As discussed below with respect to FIG. 8, the first positive electrode active material layer LL may include a first positive electrode active material AM1 and a first pore PO1. The first positive electrode active material layer LL may include a plurality of first pores PO1. The first positive electrode active material AM1 may include a compound (e.g., a lithiated intercalation compound) that can reversibly intercalate and deintercalate lithium. For example, the first positive electrode active material AM1 may include at least one type of composite oxide including lithium and metal that is or includes at least one of cobalt, manganese, nickel, and a combination thereof.

The composite oxide may be or include a lithium transition metal composite oxide, and for example, at least one of lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), or a combination thereof.

For example, the positive electrode active material may include a compound expressed by one of chemical formulae below. LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}BO_{4-c}D_{c} (where 0≤b≤0.5 and 0≤c≤0.05), LiₐNi_{1-b-c}Co_{b}B_{c}D_{α} (where 0.90≤a≤1, 0≤b≤0.5, 0≤c≤0.05, and 0<α<2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<α≤2), LiₐNi_{1-b-c}Mn_{b}B_{c}O_{2-α}F_{α} (where 0.90≤a≤1 0≤b≤0.5, 0≤c≤0.05, and 0<α≤2), LiₐNi_{b}E_{c}G_{d}O₂ (where 0.90≤a≤1, 0≤b≤0.9, 0≤c≤05, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), and LiFePO₄.

In the chemical formulae above, A may be or include at least one of Ni, Co, Mn, or a combination thereof, X may be or include at least one of Al, Ni, Co, Mn, Cr, Fe, Mg, Sr, V, a rare-earth element, or a combination thereof, D may be or include at least one of O, F, S, P, or a combination thereof, G may be or include at least one of Al, Cr, Mn, Fe, Mg, La, Ce, Sr, V, or a combination thereof, and L¹ may be or include at least one of Mn, Al, or a combination thereof.

For example, the first positive electrode active material AM1 may be or include a high-nickel-based positive electrode active material having a nickel amount that is equal to or greater than about 80 mol %, 85 mol %, 90 mol %, 91 mol %, or 94 mol % and equal to or less than about 99 mol % relative to 100 mol % of metal devoid of lithium in the lithium transition metal composite oxide. The high-nickel-based positive electrode active material may achieve high capacity, and thus may be applied to a high-capacity and high-density rechargeable lithium battery. The first positive electrode active material AM1 may be present in an amount in a range of about 85 parts by weight to about 98 parts by weight relative to 100 parts by weight of the first positive electrode active material layer LL.

### Positive Electrode Binder:

The binder maybe configured to improve attachment of positive electrode active material particles to each other, and to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

### Positive Electrode Conductive Material:

The conductive material may be included to provide an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, ketjen black, carbon fiber, carbon nano-fiber, and carbon nano-tube; a metal-based material in the form of a metal powder or metal fiber including one or more of copper, nickel, aluminum, and silver; a conductive polymer such as a polyphenylene derivative; or a mixture thereof.

### Negative Electrode:

The negative electrode 20 for the rechargeable lithium battery may include a current collector COL2 and a negative electrode active material layer AML2 located on the current collector COL2. The negative electrode active material layer AML2 may include a negative electrode active material, and may further include a binder and/or a conductive material.

For example, the negative electrode active material layer AML2 may include a negative electrode active material in a range of about 90 wt % to about 99 wt %, a binder in a range of about 0.5 wt % to about 5 wt %, and a conductive material in a range of about 0 wt % to about 5 wt %.

### Negative Electrode Binder:

The binder maybe configured to improve attachment of negative electrode active material particles to each other, and to improve attachment of the negative electrode active material to the current collector COL2. The binder may include at least one of a non-aqueous binder, an aqueous binder, a dry binder, or any combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is included as the negative electrode binder, a cellulose-based compound configured to provide viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

### Negative Electrode Conductive Material:

The conductive material may be included to provide an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, ketjen black, carbon fiber, carbon nano-fiber, and carbon nano-tube; a metal-based material in the form of a metal powder or metal fiber including one or more of copper, nickel, aluminum, and silver; a conductive polymer such as a polyphenylene derivative; or a mixture thereof.

### Negative Electrode Current Collector:

Referring back to FIG. 1, the current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material:

The negative electrode active material in the negative electrode active material layer AML2 may include at least one of a material that can reversibly intercalate and deintercalate lithium ions, lithium metal, a lithium metal alloy, a material that can dope and de-dope lithium, or a transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as at least one of non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and a metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOx (where 0<x<2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, any combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) located on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer located on a surface of the core.

The Si-based negative electrode active material or the Sn-based negative electrode active material may be included in combination with a carbon-based negative electrode active material.

### Separator:

Based on a type of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer located on one surface, or on opposite surfaces, of the porous substrate, and the coating layer includes an organic material, an inorganic material, or a combination thereof.

The porous substrate may be or include a polymer layer including at least one of polyolefin such as polyethylene and polypropylene, polyester such as at least one of polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon™, and polytetrafluoroethylene, or may be a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be in the form of a stack of a coating layer including the organic material and a coating layer including an inorganic material.

### Electrolyte

The electrolyte ELL for the rechargeable lithium battery may include a non-aqueous organic solvent and a lithium salt.

The non-aqueous organic solvent maybe configured as a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include at least one of ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be included alone or in a mixture of two or more solvents.

In addition, when a carbonate-based solvent is included, a cyclic carbonate and a linear carbonate may be mixed, and the cyclic carbonate and the linear carbonate may be mixed in a volume ratio in a range of about 1:1 to about 1:9.

The lithium salt may be or include a material that dissolves in the non-aqueous organic solvent to constitute a supply source of lithium ions in the battery, and plays a role in enabling a basic operation of the battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)borate (LiDFOB), lithium difluorobis(oxalato)phosphate (LiDFBOP), and lithium bis(oxalato)borate (LiBOB)

The additive may include a bicyclic sulfate-based compound. The bicyclic sulfate-based compound may form a solid electrolyte interface (SEI) layer on a negative electrode surface, or a protective layer on a positive electrode surface, and may have improved thermal stability, thereby improving lifetime characteristics of the rechargeable lithium battery at high temperatures.

The bicyclic sulfate-based compound may be represented by Chemical Formula 1 described below.

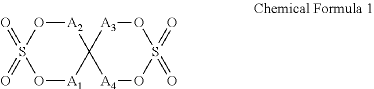

In Chemical Formula 1, A₁, A₂, A₃, and A₄ may each independently be or include a covalent bond, a substituted or unsubstituted C1-C5 alkylene group, a carbonyl group, or a sulfinyl group, in which neither A₁ nor A₂ is a covalent bond, and neither A₃ nor A₄ is a covalent bond.

For example, at least one of A₁, A₂, A₃, and A₄ may be an unsubstituted C1-C5 alkylene group or a substituted C1-C5 alkylene group, in which a substituent of the substituted C1-C5 alkylene group may be a halogen-substituted or unsubstituted C1-C20 alkyl group, a halogen-substituted or unsubstituted C1-C20 alkenyl group, a halogen-substituted or unsubstituted C2-C20 alkynyl group, a halogen-substituted or unsubstituted C3-C20 cycloalkenyl group, a halogen-substituted or unsubstituted C3-C20 heterocyclic group, a halogen-substituted or unsubstituted C6-C40 aryl group, a halogen-substituted or unsubstituted C2-C40 heteroaryl group, or a polar functional group including one or more heteroatoms.

For example, at least one of A₁, A₂, A₃, and A₄ may be an unsubstituted C1-C5 alkylene group or a substituted C1-C5 alkylene group, in which a substituent of the substituted C1-C5 alkylene group may include halogen, a methyl group, an ethyl group, a propyl group, an isopropyl group, a butyl group, a tert-butyl group, a trifluoromethyl group, a tetrafluoroethyl group, a phenyl group, a naphthyl group, a tetrafluorophenyl group, a pyrrolyl group, or a pyridinyl group, but the present disclosure is not limited thereto and any substituent capable of being included as an alkylene group may be available in the art.

For example, in the bicyclic sulfate-based compound represented by Chemical Formula 1, a substituent of the alkylene group may be a polar functional group including a heteroatom, and the heteroatom of the polar functional group may include at least one of halogen, oxygen, nitrogen, phosphorus, sulfur, silicon, and boron.

In an example embodiment, in the polar functional group including the heteroatom, a halogen substituent of the alkyl group, the alkenyl group, the alkynyl group, the cycloalkyl group, the aryl group, the heteroaryl group, the alkylaryl group, the trialkylsilyl group, or the aralkyl group may be or include fluorine (F).

For example, the bicyclic sulfate-based compound may include one or more of the compounds represented by Chemical Formulae 1-1 to 1-7 below.

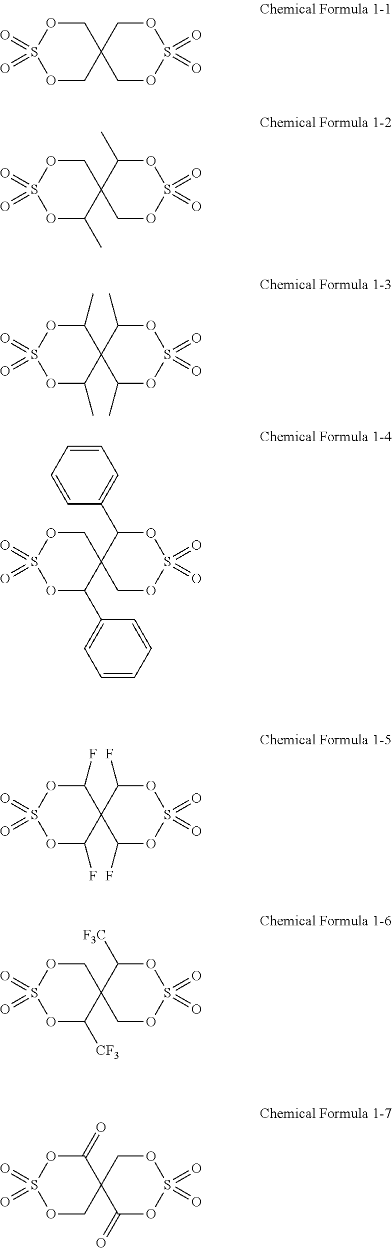

### Rechargeable Lithium Battery:

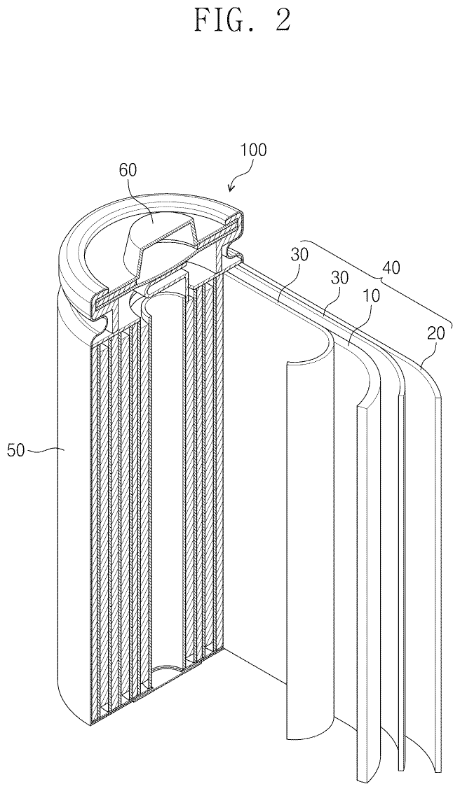

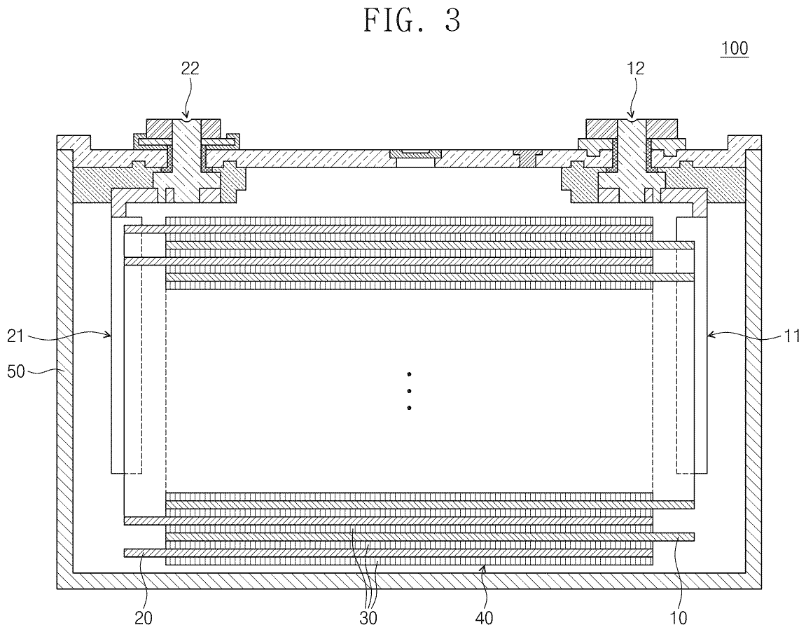

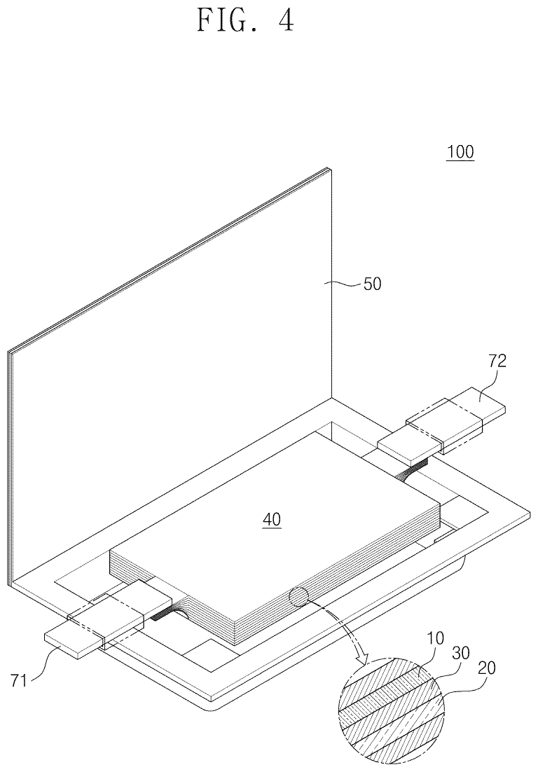

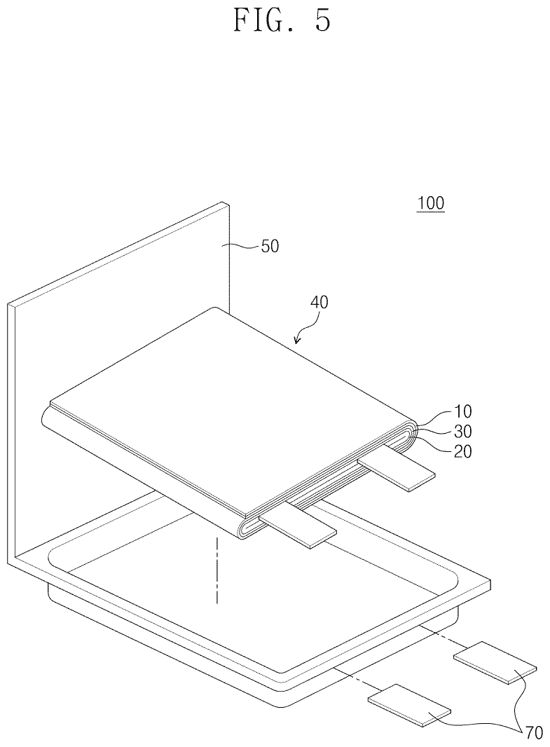

Based on a shape of a rechargeable lithium battery, the rechargeable lithium battery may be classified into cylindrical, prismatic, pouch, and coin types. FIGS. 2 to 5 illustrate simplified diagrams showing a rechargeable lithium battery according to an example embodiment of the present disclosure, with FIG. 2 showing a cylindrical battery, FIG. 3 showing a prismatic battery, and FIGS. 4 and 5 showing pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 forming an electrical path for externally inducing a current generated in the electrode assembly 40.

The rechargeable lithium battery according to an example embodiment of the present disclosure may be applicable to, e.g., automotive vehicles, mobile phones, and/or any other electrical devices, but the present disclosure is not limited thereto.

The following description focuses on a rechargeable lithium battery, and a method of fabricating the rechargeable lithium battery, according to an example embodiment of the present disclosure.

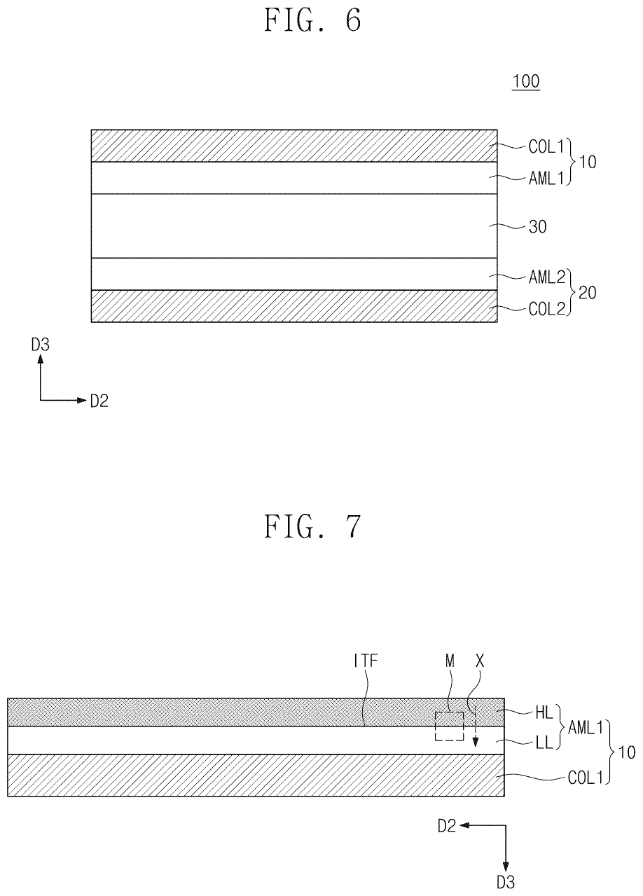

FIG. 6 illustrates a cross-sectional view showing a rechargeable lithium battery according to an example embodiment of the present disclosure. FIG. 7 illustrates a cross-sectional view showing a positive electrode of a rechargeable lithium battery according to an example embodiment of the present disclosure. FIG. 8 illustrates an enlarged view showing section “M” of FIG. 7 according to an example embodiment of the present disclosure. With reference to FIGS. 6 to 8, the following describes in detail the second positive electrode active material layer HL according to examples of the present disclosure.

Referring to FIG. 8, the second positive electrode active material layer HL may include a second positive electrode active material AM2, a second pore PO2, and a residual layer RF. The second positive electrode active material AM2 may include lithium composite transition metal oxide. For example, the second positive electrode active material AM2 may include at least one of lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), or a combination thereof. The second positive electrode active material AM2 may include the same material as the material of the first positive electrode active material AM1.

The second positive electrode active material AM2 may include a plurality of second pores PO2. The number of the second pores PO2 in the second positive electrode active material layer HL may be greater than the number of the first pores PO1 in the first positive electrode active material layer LL. A porosity of the second positive electrode active material layer HL may be greater than the porosity of the first positive electrode active material layer LL. The porosity of the first positive electrode active material layer LL may be defined to refer to a ratio of a volume of an empty space therein to a volume of the first positive electrode active material layer LL. The porosity of the second positive electrode active material layer HL may be defined to refer to a ratio of a volume of an empty space therein to a volume of the second positive electrode active material layer HL. A ratio of the porosity of the second positive electrode active material layer HL to the porosity of the first positive electrode active material layer LL may range from about 1.5 to about 10.

The second pores PO2 may be formed as an additive is dissolved by the electrolyte ELL and is evacuated from the second positive electrode active material layer HL in a subsequent process. For example, the second pores PO2 may be formed while an additive in the second positive electrode active material layer HL is released to the electrolyte ELL.

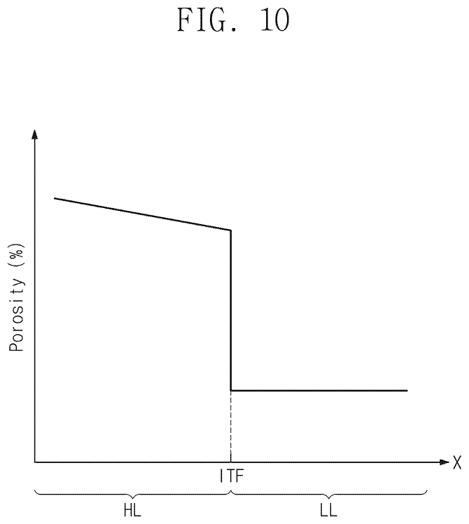

FIG. 10 illustrates a graph showing porosity as a function of X direction depicted in FIG. 7. The X direction may be a vertical direction from the second positive electrode active material layer HL toward the first positive electrode active material layer LL. Referring to FIG. 10, a porosity of the second positive electrode active material layer HL may decrease with decreasing distance from the first positive electrode active material layer LL. Alternatively, the porosity of the second positive electrode active material layer HL may be constant or increase with decreasing distance from the first positive electrode active material layer LL.

A porosity of the positive electrode 10 may be discontinuously changed at an interface ITF between the first positive electrode active material layer LL and the second positive electrode active material layer HL. For example, the porosity of the positive electrode 10 may abruptly decrease at a boundary where a transition is made from the second positive electrode active material layer HL to the first positive electrode active material layer LL. This may be due to the fact that the second positive electrode active material layer HL and the first positive electrode active material layer LL are manufactured with different positive electrode slurries and have different porosities from each other as a result.

Referring back to FIGS. 6 to 8, the second positive electrode active material layer HL may include the residual layer RF between the second positive electrode active material AM2 and at least some of the second pores PO2. The residual layer RF may be provided on an edge of the second pore PO2. The residual layer RF may be a thin film or layer. The residual layer RF may be provided on only a portion between the second positive electrode active material AM2 and the second pores PO2. A plurality of residual layers RF may be provided between one second pore PO2 and the second positive electrode active material AM2.

The residual layer RF may include sulfur (S). For example, the residual layer RF may include a sulfur-based compound. The residual layer RF may be originated from an additive of the electrolyte ELL discussed above. The residual layer RF may be or include a compound that remains after an additive is dissolved by the electrolyte ELL and evacuated from the second positive electrode active material layer HL in a subsequent process. For example, sulfur (S) of the residual layer RF may be originated from a bicyclic sulfate-based compound as an additive. The first positive electrode active material layer LL may not include the residual layer RF.

According to examples of the present disclosure, a porosity in an upper portion of the positive electrode active material layer AML1 may be greater than the porosity in a lower portion of the positive electrode active material layer AML1. As a large amount of substantially uniform pores are distributed in an upper portion of the positive electrode active material layer AML1, impregnation properties of the electrolyte ELL may be significantly improved. In addition, because only the upper portion of the positive electrode active material layer AML1 has an increased porosity, and the lower portion of the positive electrode active material layer AML1 has a relatively reduced porosity, it may be possible not only to improve impregnation properties of the electrolyte ELL with respect to the positive electrode active material layer AML1, but also to reduce or prevent a reduction in capacity of the rechargeable lithium battery. Thus, the rechargeable lithium battery may be hindered or substantially protected from the occurrence of overvoltage. As a result, the rechargeable lithium battery may improve in reliability and electrical characteristics.

FIG. 9 illustrates an enlarged view showing section “M” of FIG. 7 according to a comparative example of the present disclosure. In the comparative embodiment that follows, a detailed description of technical features repetitive to those discussed above with reference to FIG. 8 is omitted, and a difference thereof is discussed in detail.

Referring to FIG. 9, the first positive electrode active material layer LL of FIG. 9 may have a porosity that is greater than the porosity of the first positive electrode active material layer LL of FIG. 8. The first positive electrode active material layer LL and the second positive electrode active material layer HL may have the same porosity. The number of the first pores PO1 in the first positive electrode active material layer LL of FIG. 9 may be greater than the number of the first pores PO1 in the first positive electrode active material layer LL of FIG. 8. A ratio of the porosity of the second positive electrode active material layer HL to the porosity of the first positive electrode active material layer LL may range from about 0.7 to about 1.3. In the positive electrode 10 that includes the section “M” of FIG. 9, both of the first and second positive electrode active material layers LL and HL may have increased porosity. Thus, an empty space of the positive electrode 10 may be significantly increased as a whole, and the rechargeable lithium battery may decrease in capacity. In conclusion, compared to the rechargeable lithium battery according to the examples of the present disclosure, the rechargeable lithium battery according to the comparative example may decrease in capacity and electrical characteristics.

### Fabrication of Rechargeable Lithium Battery

The following description focuses on a method of fabricating a rechargeable lithium battery according to an example embodiment of the present disclosure.

A method of fabricating a rechargeable lithium battery may include manufacturing a positive electrode, manufacturing a negative electrode, and combining the positive electrode and the negative electrode to fabricate the battery.

For example, the manufacture of the positive electrode may include coating on the current collector COL1 a first positive electrode slurry to form the first positive electrode active material layer LL, coating on the first positive electrode active material layer LL a second positive electrode slurry to form the second positive electrode active material layer HL, and providing the electrolyte ELL on the first and second positive electrode active material layers LL and HL.

### Formation of First Positive Electrode Active Material Layer:

The first positive electrode slurry may be prepared by mixing a first positive electrode active material AM1, a conductive material, and a binder with each other. In the mixing method, any suitable method that can be utilized by a person skilled in the art, such as wet or dry methods, is possible and not limited to a particular method. The materials discussed above may be included as the first positive electrode active material AM1, the conductive material, and the binder.

The prepared first positive electrode slurry may be coated on the current collector COL1, and then dried and pressed to form the first positive electrode active material layer LL.

### Formation of Second Positive Electrode Active Material Layer:

The second positive electrode slurry may be prepared by mixing a second positive electrode active material AM2, a conductive material, and a binder with each other. In the mixing method, any suitable method that can be utilized by a person skilled in the art, such as wet or dry methods, is possible and not limited to a particular method. The materials discussed above may be included as the second positive electrode active material AM2, the conductive material, and the binder.

An additive of the second positive electrode slurry may include the same material as the material of an additive of the electrolyte ELL. For example, the additive of the second positive electrode slurry may include a bicyclic sulfate-based compound. Alternatively, the first positive electrode slurry may include no additive, or an extremely or substantially slight amount of an additive. A ratio of an additive concentration of the second positive electrode slurry to an additive concentration of the first positive electrode slurry may range from about 100 to about 1,000.

The prepared second positive electrode slurry may be coated on the first positive electrode active material layer LL, and then dried and pressed to form the second positive electrode active material layer HL.

### Manufacture of Negative Electrode:

A negative electrode active material, a binder, and a conductive material may be mixed to prepare a negative electrode active material slurry. The prepared negative electrode active material slurry may be coated on a negative electrode current collector, and then dried and pressed to manufacture a negative electrode.

### Fabrication of Battery:

The positive electrode and the negative electrode that are manufactured as discussed above may be combined to fabricate a fully-formed rechargeable lithium battery. A separator may be positioned between the positive electrode and the negative electrode, and an electrolyte may be introduced to fabricate the battery. Alternatively, an electrolyte layer may be provided between the positive electrode and the negative electrode to fabricate a stack-shaped battery.

The present disclosure may be applied to any battery equipped with a positive electrode active material, such as, e.g., an ordinary lithium ion battery, an all-solid-state battery, or a semi-solid battery. In addition, the shape of the fully-formed battery is not limited, and the battery may be fabricated in common configurations such as, e.g., prismatic, pouch, or cylindrical types.

In fabricating the rechargeable lithium battery according to examples of the present disclosure, an additive may be mixed to the second positive electrode slurry to form the second positive electrode active material layer HL. Afterwards, the providing of the electrolyte may include releasing an additive from the second positive electrode active material layer HL, and allowing the released additive to form a plurality of pores in the second positive electrode active material layer HL.

For example, when the electrolyte ELL is introduced into an electrode assembly, the additive included in the second positive electrode active material layer HL may be released to the electrolyte ELL. Since a space in the positive electrode is occupied by the additive in the form of a solid, when the additive may dissociate into the electrolyte ELL, the second positive electrode active material layer HL may include pores each having a large volume that are substantially uniformly formed in the spaces from which the additive is evacuated.

The second positive electrode active material layer HL may include a non-released portion of the additive in the second positive electrode active material layer HL, and the electrolyte ELL may include a released portion of the additive to the electrolyte ELL. The non-released additive may remain as a residual layer RF in the second positive electrode active material layer HL. Thus, the residual layer RF may include sulfur (S).

The additive included in the second positive electrode active material layer HL and the additive included in the electrolyte ELL may be the same as each other, and may be in amounts that are different from each other. In addition, since the additive is a compound included as an ordinary additive for the rechargeable lithium battery, the electrolyte ELL may include the additive to improve battery performance and stability.

As a larger amount of pores are substantially uniformly distributed in the second positive electrode active material layer HL than in the first positive electrode active material layer LL, there may be a remarkable or substantial improvement in impregnation properties with respect to the second positive electrode active material layer HL, and lithium ion pathways may be obtained to improve a capacity, lifetime characteristics, and rapid charging properties of the battery.

FIG. 12 is a flow chart illustrating a method of fabricating a rechargeable lithium battery, according to an example embodiment. In FIG. 12, the method 1200 includes operation 1210, which includes coating on a current collector a first positive electrode slurry to form a first positive electrode active material layer. Operation 1220 includes coating on the first positive electrode active material layer a second positive electrode slurry to form a second positive electrode active material layer. For example, the second positive electrode slurry includes an additive. In another example, a ratio of an additive concentration of the second positive electrode slurry to an additive concentration of the first positive electrode slurry is in a range of about 100 to about 1,000. In yet another example, the second positive electrode active material layer further includes a positive electrode active material, and a residual layer between the positive electrode active material and the plurality of pores, wherein the residual layer includes sulfur (S). In a further example, a porosity of the second positive electrode active material layer is greater than a porosity of the first positive electrode active material layer. In another example, a porosity of the rechargeable lithium battery decreases at an interface between the first and second positive electrode active material layers.

Operation 1230 includes providing an electrolyte on the first and second positive electrode active material layers. In an example, providing the electrolyte includes releasing the additive from the second positive electrode active material layer, and allowing the released additive to form a plurality of pores in the second positive electrode active material layer. In an example, the additive is represented by Chemical Formula 1:

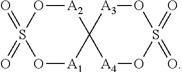

In Chemical Formula 1, A₁, A₂, A₃, and A₄ each independently includes a covalent bond, a substituted or unsubstituted C1-C5 alkylene group, a carbonyl group, or a sulfinyl group, neither A₁ nor A₂ is a covalent bond, and neither A₃ nor A₄ is a covalent bond.

The following describes detailed example embodiments for implementing the present disclosure. The present disclosure may include not only the aforementioned example embodiments, but also embodiments that can be simply redesigned or readily modified. Additionally, the present disclosure may encompass technologies that can be readily implemented through modifications of the example embodiments. Accordingly, the scope of the present disclosure should not be limited to the aforementioned example embodiments, but should be defined by the claims below and their equivalents.

### Embodiment 1

### Formation of First Positive Electrode Active Material Layer:

LiNi_{0.91}Co_{0.66}Al_{0.13}V_{0.02}O₂ (referred to hereinafter as NCA) as a positive electrode active material (Gen. 6, Ni₉₁V₂), polyvinylidene fluoride as a binder, and carbon nano-tube as a conductive material are mixed in a weight ratio of 97:2:1, and the mixture was dispersed in N-methyl pyrrolidone to prepare a first positive electrode slurry.

The first positive electrode slurry was coated on an Al foil current collector of 14 μm in thickness, and dried at 200° C. and pressed to form a first positive electrode active material layer.

### Formation of Second Positive Electrode Active Material Layer:

LiNi_{0.91}Co_{0.66}Al_{0.13}V_{0.02}O₂ (referred to hereinafter as NCA) as a positive electrode active material (Gen. 6, Ni₉₁V₂), polyvinylidene fluoride as a binder, and carbon nano-tube as a conductive material are mixed in a weight ratio of 97:2:1, and the mixture is dispersed in N-methyl pyrrolidone to prepare a basic positive electrode slurry. A compound represented by Chemical Formula 1-1 as an additive is mixed to the basic positive electrode slurry to prepare a second positive electrode slurry. For reference, the expression “wt %” in the following positive electrode slurry composition is based on a total amount of positive electrode slurry (positive electrode active material+binder+conductive material+additive).

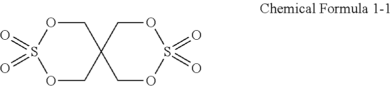 [SMILES: O=S1(=O)OCC2(CO1)COS(=O)(=O)OC2]

The second positive electrode slurry is coated on the first positive electrode active material layer, and then dried at 200° C. and pressed to form a second positive electrode active material layer.

### Manufacture of Negative Electrode and Electrolyte:

Artificial graphite as a negative electrode active material, styrene-butadiene rubber as a binder, and carboxymethylcellulose as a thickener are mixed in a weight ratio of 97:1:2, and the mixture is dispersed in distilled water to prepare a negative electrode active material slurry. The negative electrode active material slurry is coated on a copper foil current collector of 10×m in thickness, and then dried 100° C. and pressed to manufacture a negative electrode.

An electrolyte is prepared by dissolving 1.5 M of LiPF₆ lithium salt in a non-aqueous organic solvent containing ethylene carbonate (EC), ethylmethyl carbonate (EMC), and dimethyl carbonate (DMC) that are mixed in a volume ratio of 20:10:70 in the foregoing sequence.

### Fabrication of Rechargeable Lithium Battery:

After a multi-layered polyethylene-polypropylene separator of 25 μm in thickness is interposed between the positive electrode and the negative electrode to obtain an electrode assembly, the electrode assembly is inserted into a circular battery casing, and then the electrolyte is introduced to fabricate a rechargeable lithium battery of Embodiment 1.

### Embodiment 2

A rechargeable lithium battery is fabricated in the same method as in Embodiment 1, with a difference that 0.1 wt % of a compound represented by Chemical Formula 1-2 as the additive is mixed to prepare the second positive electrode slurry.

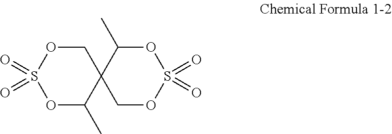 [SMILES: CC1OS(=O)(=O)OCC12COS(=O)(=O)OC2C]

### Comparative 1

A rechargeable lithium battery is fabricated in the same method as in Embodiment 1, with a difference that the second positive electrode active material layer is formed without adding the additive to the second positive electrode slurry.

### Comparative 2

A rechargeable lithium battery is fabricated in the same method as in Embodiment 1, with a difference that 0.1 wt % of a compound represented by Chemical Formula 1-1 as the additive is also mixed to the first positive electrode slurry to prepare the first positive electrode active material layer.

Table 1 below lists the examples and the comparative examples fabricated as discussed above.

TABLE 1

Additive (amount)

| | First positive | Second positive |
|---|---|---|
| | electrode slurry | electrode slurry |
| Embodiment 1 | X | ◯ (0.1 wt %) |
| Embodiment 2 | X | ◯ (0.1 wt %) |
| Comparative 1 | X | X |
| Comparative 2 | ◯ (0.1 wt %) | ◯ (0.1 wt %) |

### Evaluation 1: Overvoltage

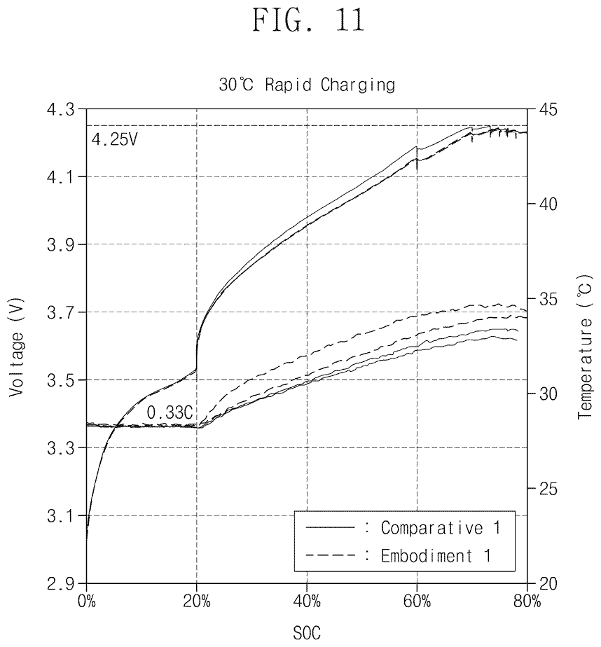

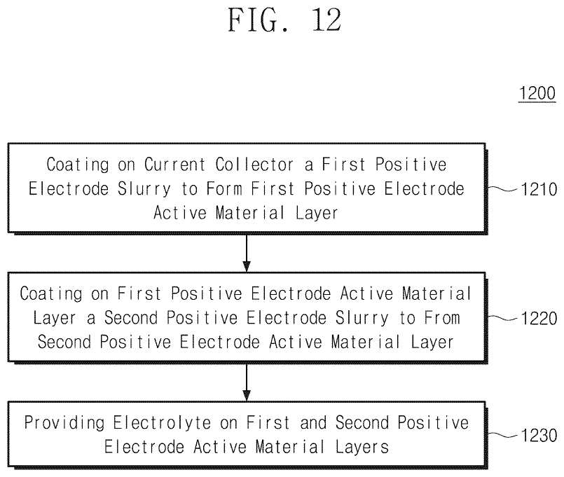

An overvoltage of each of the rechargeable lithium batteries according to Embodiment 1, Embodiment 2, and Comparative 1 was evaluated. For example, at 30° C., the charging time and lithium deposition amount were evaluated according to the state of charge (SOC) at 4.25 V and 4.3 V cutoffs. Table 2 below lists the results. FIG. 11 illustrates a graph showing temperature and voltage in accordance with 4.25 V cutoff of Embodiment 1 and Comparative 1.

TABLE 2

| | | Comparative 1 | | Embodiment 1 | | Embodiment 2 | |
|---|---|---|---|---|---|---|---|
| | | 4.25 V | 4.3 V | 4.25 V | 4.3 V | 4.25 V | 4.3 V |
| | | Cutoff | Cutoff | Cutoff | Cutoff | Cutoff | Cutoff |
| | | [V] | [V] | [V] | [V] | [V] | [V] |
| Charging rate | 2.2 C | 4.190 | 4.192 | 4.157 | 4.159 | 4.160 | 4.162 |
| (C-rate) | 2.6 C | 4.248 | 4.250 | 4.229 | 4.232 | 4.230 | 4.234 |
| | 3.1 C | 4.250 | 4.261 | 4.244 | 4.247 | 4.243 | 4.247 |
| | 3.5 C | 4.242 | 4.253 | 4.239 | 4.242 | 4.240 | 4.243 |
| | 4 C | 4.233 | 4.245 | 4.232 | 4.235 | 4.234 | 4.235 |

| | | | | | | |
|---|---|---|---|---|---|---|
| SOC | 78.4% | 80.0% | 80.0% | 80.0% | 80.0% | 80.0% |
| Charging time | 9.58 | 9.88 | 9.92 | 9.92 | 9.91 | 9.90 |
| Lithium deposition amount | 0.20% | 0.23% | 0.19% | 0.16% | 0.17% | 0.15% |

Referring to Table 2 and FIG. 11, the rechargeable lithium batteries according to Embodiment 1 and Embodiment 2 did not exhibit an overvoltage, but the rechargeable lithium battery according to Comparative 1 exhibited an overvoltage. For example, in the case of Comparative 1, an overvoltage of 4.250 V was produced at a charging rate of 3.1 C with 4.25 cutoff. In addition, high voltages of 4.253 V, 4.261 V, and 4.250 V were generated respectively at charging rates of 2.6 C, 3.1 C, and 3.5 C with 4.3 cutoff.

In addition, compared to the rechargeable lithium battery according to Comparative 1, the rechargeable lithium battery according to Embodiment 1 exhibited high temperature during charging. Since high temperature may be advantageous for rapid charging, the rechargeable lithium battery according to Embodiment 1 may be more suitable for rapid charging compared to the rechargeable lithium battery according to Comparative 1.

Furthermore, in the case of Comparative 1, a phenomenon occurred where the state of charge (SOC) reached 78.4% and a charging rate did not reach 80.0%. The lithium deposition amount in Embodiment 1 and Embodiment 2 was relatively lower than the lithium deposition amount in Comparative 1. Therefore, it may be ascertained that, when the additive is provided to an upper portion of the positive electrode active material layer to increase the porosity, the overvoltage phenomenon is prevented and the lithium deposition amount is reduced. As a result, in comparison with an ordinary rechargeable lithium battery, the rechargeable lithium battery according to the present disclosure may improve in reliability and electrical characteristics.

A positive electrode of a rechargeable lithium battery according to an example embodiment may include an upper portion which porosity is relatively high, and thus it may be possible to improve impregnation properties of an electrolyte.

A method of fabricating a rechargeable lithium battery according to an example embodiment may solve or address stability and performance issues of the rechargeable lithium battery.

What is claimed is:

1. A rechargeable lithium battery, comprising:
a positive electrode that comprises a current collector;
an electrolyte; and
a negative electrode,
wherein the positive electrode comprises:
a first positive electrode active material layer on the current collector; and
a second positive electrode active material layer on the first positive electrode active material layer,
wherein the second positive electrode active material layer comprises:
a positive electrode active material that comprises a lithium composite transition metal oxide;
a plurality of pores; and
a residual layer between the positive electrode active material and the pores,
wherein the residual layer comprises sulfur (S).

2. The rechargeable lithium battery of claim 1, wherein a porosity of the second positive electrode active material layer is greater than a porosity of the first positive electrode active material layer.

3. The rechargeable lithium battery of claim 1, wherein the electrolyte comprises an additive,
wherein the additive comprises a bicyclic sulfate-based compound.

4. The rechargeable lithium battery of claim 3, wherein the bicyclic sulfate-based compound is represented by Chemical Formula 1, 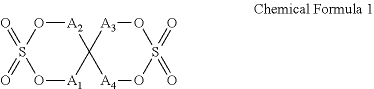
wherein, in Chemical Formula 1,
A₁, A₂, A₃, and A₄ each independently comprises a covalent bond, a substituted or unsubstituted C1-C5 alkylene group, a carbonyl group, or a sulfinyl group,
A₁ and A₂ are not both covalent bonds, and
A₃ and A₄ are not both covalent bonds.

5. The rechargeable lithium battery of claim 4, wherein the compound represented by Chemical Formula 1 comprises at least one of compounds represented by Chemical Formula 1-1 to Chemical Formula 1-7,

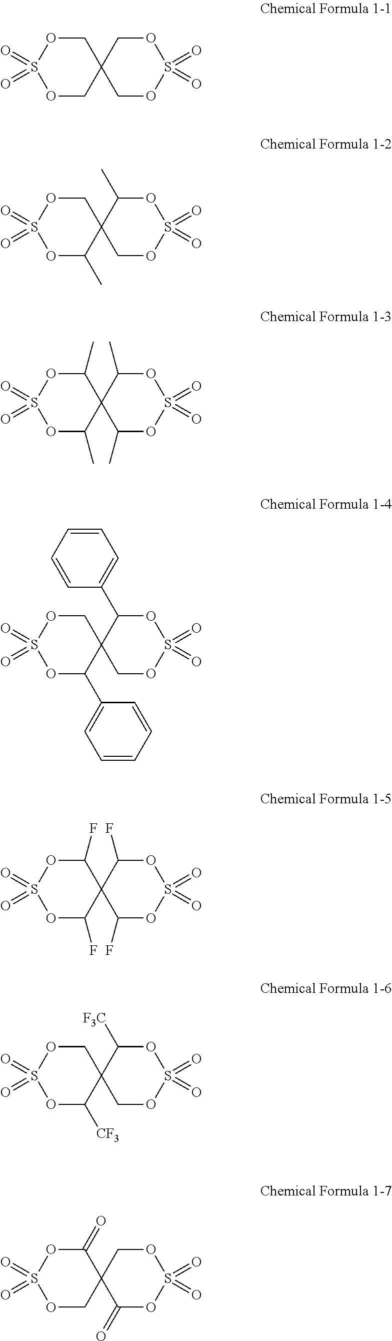

6. The rechargeable lithium battery of claim 3, wherein the residual layer is originated from the additive.

7. The rechargeable lithium battery of claim 3, wherein the pores of the second positive electrode active material layer are formed as a result of an additive in the second positive electrode active material layer being released to the electrolyte.

8. The rechargeable lithium battery of claim 3, wherein the first positive electrode active material layer does not comprise the residual layer.

9. The rechargeable lithium battery of claim 1, wherein the positive electrode active material comprises at least one of lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), and lithium iron phosphate (LFP).

10. The rechargeable lithium battery of claim 1, wherein the positive electrode further comprises at least one of a binder and a conductive material.

11. The rechargeable lithium battery of claim 1, wherein the electrolyte comprises an organic solvent and a lithium salt.

12. The rechargeable lithium battery of claim 1, wherein a porosity of the positive electrode decreases at an interface between the first positive electrode active material layer and the second positive electrode active material layer.

13. A method of fabricating a rechargeable lithium battery, the method comprising:
coating on a current collector a first positive electrode slurry to form a first positive electrode active material layer;
coating on the first positive electrode active material layer a second positive electrode slurry to form a second positive electrode active material layer; and
providing an electrolyte on the first and second positive electrode active material layers,
wherein the second positive electrode slurry comprises an additive, and
wherein providing the electrolyte comprises:
releasing the additive from the second positive electrode active material layer; and
allowing the released additive to form a plurality of pores in the second positive electrode active material layer.

14. The method of claim 13, wherein a ratio of an additive concentration of the second positive electrode slurry to an additive concentration of the first positive electrode slurry is in a range of about 100 to about 1,000.

15. The method of claim 13, wherein the second positive electrode active material layer further comprises:
a positive electrode active material; and
a residual layer between the positive electrode active material and the plurality of pores,
wherein the residual layer comprises sulfur (S).

16. The method of claim 13, wherein a porosity of the second positive electrode active material layer is greater than a porosity of the first positive electrode active material layer.

17. The method of claim 13, wherein a porosity of the rechargeable lithium battery decreases at an interface between the first and second positive electrode active material layers.

18. The method of claim 13, wherein the additive is represented by Chemical Formula 1, 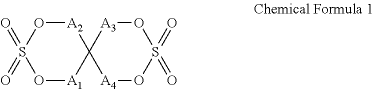
wherein, in Chemical Formula 1,
A₁, A₂, A₃, and A₄ each independently comprises a covalent bond, a substituted or unsubstituted C1-C5 alkylene group, a carbonyl group, or a sulfinyl group,
A₁ and A₂ are not both covalent bonds, and
A₃ nor A₄ are not both covalent bonds.

19. A positive electrode for a rechargeable lithium battery, the positive electrode comprising:
a current collector;
a first positive electrode active material layer on the current collector; and
a second positive electrode active material layer on the first positive electrode active material layer,
wherein the second positive electrode active material layer comprises:
a positive electrode active material that comprises a lithium composite transition metal oxide;
a plurality of pores; and
a residual layer between the positive electrode active material and the pores,
wherein the residual layer comprises sulfur (S).

20. The positive electrode of claim 19, wherein a porosity of the second positive electrode active material layer is greater than a porosity of the first positive electrode active material layer.
